(19) United States
(12) Patent Application Publication
(10) Pub. No.: US 2025/0163983 A1
(43) Pub. Date: May 22, 2025

(54) 3D VARIABLE DAMPING VIBRATION ISOLATOR BASED ON RUBBER FRICTION AND EXTRUSION MECHANISM

(71) Applicant: DALIAN UNIVERSITY OF TECHNOLOGY, Dalian, Liaoning (CN)

(72) Inventors: Zhiqian DONG, Dalian, Liaoning (CN); Gang LI, Dalian, Liaoning (CN); Baolin SUN, Dalian, Liaoning (CN); Hongnan LI, Dalian, Liaoning (CN)

(21) Appl. No.: 18/560,630

(22) PCT Filed: Feb. 3, 2023
(86) PCT No.: PCT/CN2023/074350

§ 371 Date: Dec. 24, 2024

(30) Foreign Application Priority Data
Nov. 21, 2022 (CN) 202211451522.4

(51) Int. Cl. F16F 7/08

(52) U.S. Cl. CPC F16F 7/08; F16F 2222/04; F16F 2238/04

(57) ABSTRACT

A 3D variable damping vibration isolator based on rubber friction and extrusion mechanism is composed of a base, an upper plate, a vibration isolation spring, “ [symbol] ” shaped bolts, lock nuts, damped rubber blocks and a shell. The damped rubber blocks are vulcanized and bonded to the external vertical surfaces of vertical steel angles uniformly distributed on the base and are opposite to each other in pairs; the upper end of each “ [symbol] ” shaped bolt is fixed to the upper plate by upper and lower (two) lock nuts, and cross bars at the lower end are squeezed by the damped rubber blocks on both sides; contact surfaces of the damped rubber blocks and the “ [symbol] ” shaped bolts are flat-a design of variable cross-section. The vibration isolation spring is sheathed between the base and a lug boss in the center of the upper plate.

### TECHNICAL FIELD

The present invention belongs to the fields of vibration isolation and vibration control, and relates to a 3D variable damping vibration isolator based on rubber friction and extrusion mechanism.

### BACKGROUND

A building in a natural environment will be disturbed by various loads and vibrate. Vibration is one of the most important environmental factors that affect the normal operation and service life of precision equipment. Unreasonable vibration in a special environment will cause irreversible damage to the equipment, resulting in a great economic loss. In addition, certain precision equipment even needs to be able to maintain a normal operating state in a vibration environment. Therefore, precision equipment often has relatively strict control requirements for environmental vibration. In order to ensure that important precision equipment in the vibration environment still has normal operating capacity and service life, and avoid damage to the equipment due to vibration, a vibration isolation device is usually arranged between the equipment and a foundation to weaken the transmission of vibration.

At present, in most of the common vibration isolation devices, only the vibration control in a single direction is considered, and the applicability of the devices to complex working conditions is poor. The vast majority of vibrations in the environment are often not in a single direction with a fixed frequency and a constant amplitude, but are more often in a complex multi-dimensional comprehensive motion state. Therefore, vibration isolation design should be developed from a single direction to multiple dimensions. At present, 3D vibration isolation design has two ideas: the first is to conduct vertical and horizontal designs separately and then combine the designs reasonably, that is, to decouple the vertical and horizontal designs, the advantage of which is that three-way parameters can be considered separately, combined and optimized to achieve a good three-way vibration isolation effect; the second design idea is to consider both vertical and horizontal designs at the same time, that is, it is required that an elastic element as the main body of vibration isolation should have appropriate three-way stiffness and damping at the same time, but this method can only make a compromise between the vertical and horizontal vibration isolation designs.

Introducing nonlinear damping into a vibration isolation device is one of the most effective ways to improve the vibration isolation effect, but part of the nonlinear damping is realized by geometric nonlinearity and will lead to a complex structure and increase production cost when introduced into a vibration isolation device, and it is particularly difficult to introduce three-way nonlinear damping into a 3D vibration isolation device. Nonlinearity of dry friction damping can be realized by changing the contact force, and applying dry friction damping to a vibration isolation device through a reasonable structure will not make the structure of the vibration isolation device complex.

### SUMMARY

In order to improve the universality of a vibration isolation device and solve the vibration isolation requirements in various complex vibration working conditions, the present invention provides a 3D variable damping vibration isolator based on rubber friction and extrusion mechanism, in which “ [symbol] ” shaped bolts and damped rubber blocks are squeezed to provide horizontal stiffness, thus to achieve 3D vibration isolation, the contact surfaces of the “ [symbol] ” shaped bolts and the damped rubber blocks adopt a design of variable cross-section, and nonlinear damping in each direction in a 3D vibration isolation device can be realized by the cooperation of the “ [symbol] ” shaped bolts and the damped rubber blocks, thus to improve the vibration isolation effect. The present invention has a simple structure and has a good self-resetting ability in horizontal vibration, the design of variable cross-section can effectively suppress resonance, and rubber has good buffering and noise reduction functions.

The present invention has the following technical solution:
A 3D variable damping vibration isolator based on rubber friction and extrusion mechanism, comprising a base, an upper plate, a vibration isolation spring, “ [symbol] ” shaped bolts, lock nuts, damped rubber blocks and a shell. The damped rubber blocks are vulcanized and bonded to the external vertical surfaces of vertical steel angles uniformly distributed on the base and are opposite to each other in pairs; the upper end of each “ [symbol] ” shaped bolt is fixed to the upper plate by upper and lower (two) lock nuts, and cross bars at the lower end are squeezed by the damped rubber blocks on both sides; the contact surfaces of the damped rubber blocks and the “ [symbol] ” shaped bolts are flat-a design of variable cross-section; the vibration isolation spring is sheathed between the base and a lug boss in the center of the upper plate; the shell is fixed to the base by screws, the upper end of each “ [symbol] ” shaped bolt is threaded, the lower end is provided with at least two parallel cross bars, the friction surfaces of the end parts of the cross bars in contact with the damped rubber blocks are convex, and each friction surface is flat from the center to the periphery-a design of variable cross-section.

The damped rubber blocks are cuboid, and the friction surfaces of the damped rubber blocks in contact with the cross bars at the lower end of each “ [symbol] ” shaped bolt are concave; the number of the friction surfaces is the same as the number of the cross bars at the lower end of each “ [symbol] ” shaped bolt, the concave friction surfaces of the damped rubber blocks are seamlessly fitted with the convex friction surfaces of the “ [symbol] ” shaped bolts, and each friction surface is flat from the center to the periphery-a design of variable cross-section.

The upper end of each “ [symbol] ” shaped bolt is fixed to the upper plate by two lock nuts, and the position of the “ [symbol] ” shaped bolt is adjusted by changing the positions of the two lock nuts to ensure that the cross bars at the lower end of the “ [symbol] ” shaped bolt are always in the centers of the friction surfaces of the damped rubber blocks.

The “ [symbol] ” shaped bolts and damped rubber blocks are squeezed to provide horizontal stiffness, thus to achieve the 3D vibration isolation effect.

When the “ [symbol] ” shaped bolts move relative to the damped rubber blocks, three-way variable damping can be generated.

The present invention has the following beneficial effects:

The present invention can be widely applied to the vibration isolation of various equipment or foundations; in horizontal vibration, the “ [symbol] ” shaped bolts and damped rubber blocks are squeezed to provide horizontal stiffness, and different vibration isolation stiffness requirements can be met by changing the parameters of the contact surfaces and the hardness of the damped rubber blocks; when the “ [symbol] ” shaped bolts move relative to the damped rubber blocks, friction damping can be generated, and as the contact surfaces of the damped rubber blocks and the “ [symbol] ” shaped bolts are flat-a design of variable cross-section, variable damping can be generated between the “ [symbol] ” shaped bolts and the damped rubber blocks during vibration, which can not only ensure a good vibration isolation effect, but also effectively suppress resonance. In addition, because each “ [symbol] ” shaped bolt is located between two opposite damped rubber blocks, and both ends of each cross bar at the lower end are squeezed by the damped rubber blocks, the present invention has a good self-resetting ability in horizontal vibration.

### DESCRIPTION OF DRAWINGS

FIG. 1 is a structural schematic diagram of a device of the present invention in a normal working condition.

FIG. 2 is an appearance schematic diagram of a device of the present invention in a normal working condition.

FIG. 3 is an isometric schematic diagram of a damped rubber block in a device of the present invention.

FIG. 4 is a sectional view of a damped rubber block in a device of the present invention.

FIG. 5 is an isometric schematic diagram of a “ [symbol] ” shaped bolt in a device of the present invention.

FIG. 6 is a sectional view of a “ [symbol] ” shaped bolt in a device of the present invention.

In the figures: 1 base; 2 upper plate; 3 vibration isolation spring; 4 “ [symbol] ” shaped bolt; 5 lock nut; 6 damped rubber block; 7 shell.

### DETAILED DESCRIPTION

The present invention will be further described below in combination with the drawings in the embodiment of the present invention.

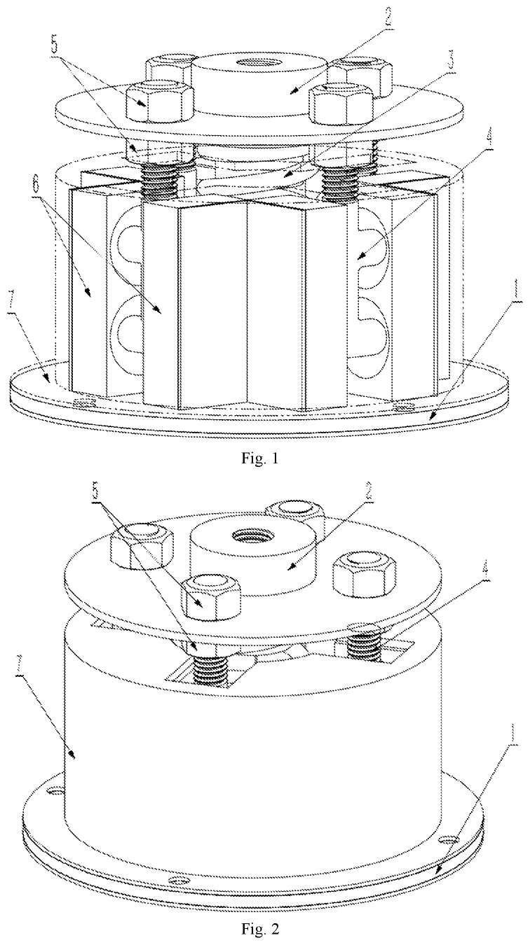

FIG. 1 and FIG. 2 show structural and appearance schematic diagrams of a 3D variable damping vibration isolator based on rubber friction and extrusion mechanism in an embodiment of the present invention in a normal working condition. The vibration isolator is composed of a base 1, an upper plate 2, a vibration isolation spring 3, “ [symbol] ” shaped bolts 4, lock nuts 5, damped rubber blocks 6 and a shell 7.

In the specific implementation process, the vibration isolator uses base 1 as a foundation, the center of the base 1 is provided with a lug boss used for restricting the vertical vibration isolation spring 3, four vertical steel angles are uniformly distributed around the lug boss, and the external vertical surfaces of the vertical steel angles are opposite to each other in pairs, which provides a certain horizontal deformation space for the vibration isolation spring 3, can bear the load produced when the damped rubber blocks 6 are squeezed, and improves the stability of the device.

In the specific implementation process, the lower end of the vibration isolation spring 3 is sheathed with the lug boss in the center of the base 1, and the upper end is sheathed with the lug boss in the center of the bottom surface of the upper plate 2, which restricts the position of the vibration isolation spring 3, and can ensure the horizontal deformation ability of the vibration isolation spring 3.

In the specific implementation process, the center of the top surface of the upper plate 2 is provided with a lug boss, the lug boss can bear the base of equipment requiring vibration isolation, and the center of the lug boss has a screw hole which can be connected with the equipment or base 1 above; the center of the bottom surface of the upper plate 2 is also provided with a lug boss which is used for restricting the vibration isolation spring 3 and transmitting the horizontal load of the upper plate 2 at the same time, thus to enable the vibration isolation spring 3 to have a horizontal deformation; in addition, four holes are formed around the lug bosses of the upper plate 2, which can allow the upper ends of the “ [symbol] ” shaped bolts 4 to pass through.

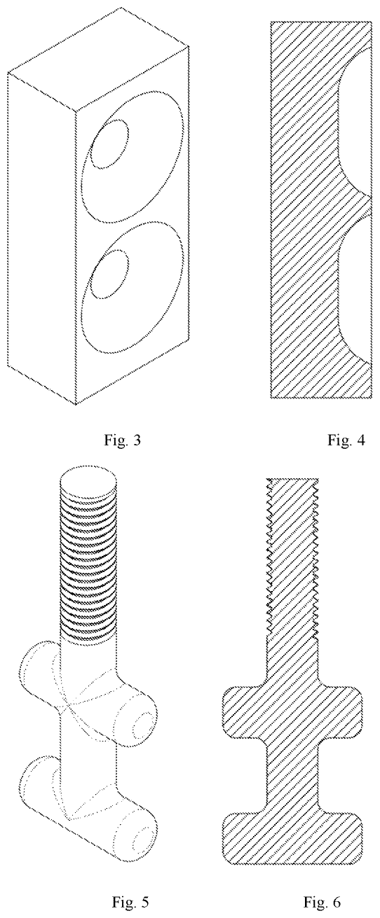

In the specific implementation process, the cuboid damped rubber blocks 6 shown in FIG. 3 and FIG. 4 are vulcanized and bonded to the external vertical surfaces of the vertical steel angles uniformly distributed on the base 1 and are opposite to each other in pairs, the two friction surfaces of the damped rubber blocks 6 in contact with each cross bar at the lower end of each “ [symbol] ” shaped bolt 4 are concave and symmetric in any diameter direction, each friction surface is flat from the center to the periphery-a design of variable cross-section, and the outermost rim of each damped rubber block 6 is provided with a protective layer with a certain thickness and can resist part of an impact load.

In the specific implementation process, the upper end of each “ [symbol] ” shaped bolt 4 shown in FIG. 5 and FIG. 6 is threaded, and the upper end of the bolt penetrates through a hole reserved in the upper plate 2 and is then fixed to the upper plate 2 by upper and lower (two) lock nuts 5; the lower end of each “ [symbol] ” shaped bolt 4 is provided with two parallel cross bars, the two friction surfaces of the end parts of either cross bar in contact with the damped rubber blocks 6 are convex, and each friction surface is flat from the center to the periphery-a design of variable cross-section. The initial position of each cross bar at the lower end of each “+” shaped bolt 4 is in the center of each friction surface of a corresponding damped rubber block 6, and the “+” shaped bolt 4 and the damped rubber block 6 are squeezed by each other; after the vibration isolator is subjected to a certain load, the position of the “ [symbol] ” shaped bolt 4 can be adjusted by the two lock nuts 5 to ensure that the cross bars at the lower end of each bolt are always in the centers of the friction surfaces of the corresponding damped rubber blocks 6.

In the specific implementation process, the shell 7 is fixed to the base 1 by screws.

In the specific implementation process, when the vibration isolator is in vertical vibration, the stiffness is provided by the vibration isolation spring 3, the “ [symbol] ” shaped bolts 4 is driven by the upper plate 2 to move relative to the damped rubber blocks 6, certain friction damping can be generated between the “ [symbol] ” shaped bolts 4 and the damped rubber blocks 6, and as the contact surfaces of the rubber blocks and the bolts are flat-a design of variable cross-section, the damping is small at an equilibrium position and large at a position away from the equilibrium position, which can not only ensure the vibration isolation effect, but also effectively suppress resonance.

In the specific implementation process, when the vibration isolator is in horizontal vibration, the vibration isolation spring 3 has a horizontal deformation under the action of a horizontal vibration force, the damped rubber blocks 6 not in vibration direction are extruded by the “ [symbol] ” shaped bolts 4 to provide horizontal stiffness, the damped rubber blocks 6 in vibration direction will move in vibration direction relative to the “ [symbol] ” shaped bolts 4 to provide certain damping, and as the contact surfaces of the rubber blocks and the bolts are flat-a design of variable cross-section, the isolation device will also have variable damping in horizontal vibration, which can both ensure the vibration isolation effect and effectively suppress resonance. In addition, because each “ [symbol] ” shaped bolt 4 is located between two opposite damped rubber blocks 6, and both ends of each cross bar at the lower end are squeezed by the damped rubber blocks 6, the present invention has a good self-resetting ability in horizontal vibration.

To sum up, the 3D variable damping vibration isolator based on rubber friction and extrusion mechanism in the present invention has the characteristics that the damping is small at an equilibrium position and large at a position away from the equilibrium position in all directions of vibration, and therefore has three-way variable damping; the damping parameters of the vibration isolation device can be changed by changing the size of the contact surfaces of the damped rubber blocks 6 and the “ [symbol] ” shaped bolts 4, and the horizontal stiffness can be designed by changing the hardness of the damped rubber blocks 6, therefore the present invention has designable three-way stiffness and damping. The present invention has a simple structure, a controllable cost and a good application prospect.

1. A 3D variable damping vibration isolator based on rubber friction and extrusion mechanism, comprising a base, an upper plate, a vibration isolation spring, “ [symbol] ” shaped bolts, lock nuts, damped rubber blocks and a shell; the center of the base is provided with a lug boss used for restricting the vertical vibration isolation spring, and four vertical steel angles are uniformly distributed around the lug boss; the damped rubber blocks- are vulcanized and bonded to the external vertical surfaces of vertical steel angles uniformly distributed on the base and are opposite to each other in pairs; the upper end of each “ [symbol] ” shaped bolt is fixed to the upper plate by upper and lower lock nuts, and cross bars at the lower end are squeezed by the damped rubber blocks on both sides; the contact surfaces of the damped rubber blocks and the “ [symbol] ” shaped bolts are flat-a design of variable cross-section; the vibration isolation spring- is sheathed between the base and a lug boss in the center of the upper plate; the shell is fixed to the base by screws, the upper end of each “ [symbol] ” shaped bolt is threaded, the lower end is provided with at least two parallel cross bars, the friction surfaces of the end parts of the cross bars in contact with the damped rubber blocks are convex, and each friction surface is flat from the center to the periphery-a design of variable cross-section.

2. The 3D variable damping vibration isolator based on rubber friction and extrusion mechanism according to claim 1, wherein the damped rubber blocks are cuboid, and the friction surfaces of the damped rubber blocks in contact with the cross bars at the lower end of each “ [symbol] ” shaped bolt are concave; the number of the friction surfaces is the same as the number of the cross bars at the lower end of each “ [symbol] ” shaped bolt, the concave friction surfaces of the damped rubber blocks are seamlessly fitted with the convex friction surfaces of the “ [symbol] ” shaped bolts, and each friction surface is flat from the center to the periphery—a design of variable cross-section.

3. The 3D variable damping vibration isolator based on rubber friction and extrusion mechanism according to claim 1- or 2, wherein the upper end of each “ [symbol] ” shaped bolt- is fixed to the upper plate by two lock nuts, and the position of the “ [symbol] ” shaped bolt- is adjusted by changing the positions of the two lock nuts to ensure that the cross bars at the lower end of the “ [symbol] ” shaped bolt- are always in the centers of the friction surfaces of the damped rubber blocks.

4. (canceled)

5. (canceled)

6. The 3D variable damping vibration isolator based on rubber friction and extrusion mechanism according to claim 1, wherein the center of the top surface of the upper plate is provided with a lug boss, the lug boss can bear the base of equipment requiring vibration isolation, and the center of the lug boss has a screw hole.

7. The 3D variable damping vibration isolator based on rubber friction and extrusion mechanism according to claim 2, wherein the center of the top surface of the upper plate is provided with a lug boss, the lug boss can bear the base of equipment requiring vibration isolation, and the center of the lug boss has a screw hole.

8. The 3D variable damping vibration isolator based on rubber friction and extrusion mechanism according to claim 3, wherein the center of the top surface of the upper plate is provided with a lug boss, the lug boss can bear the base of equipment requiring vibration isolation, and the center of the lug boss has a screw hole.
